(19) United States
(12) Patent Application Publication
(10) Pub. No.: US 2013/0019264 A1
(43) Pub. Date: Jan. 17, 2013

(54) Remote Control Learning/Identification Module in Combination with a TV Set

(71) Applicant: Ming-Zhao Rui, Xiamen (CN)

(72) Inventor: Ming-Zhao Rui, Xiamen (CN)

(21) Appl. No.: 13/545,033

(22) Filed: Jul. 10, 2012

(30) Foreign Application Priority Data
Jul. 12, 2011 (CN) 201110195068.6

(51) Int. Cl. H04N 5/44

(52) U.S. Cl. 725/37

(57) ABSTRACT

A remote control learning/identification module which is built in a TV set consists of command receiving module, store module, activation module and interface module, and processing module. The processing module is connected to the command receiving module, the store module, the activation module and the interface module. The command receiving module receives infrared signal from the remote control and the infrared signal is magnified and modulated to become a level signal. The store module stores system program, standard protocol, the mapping unit information and the user's information. The activation module sends in predetermined command to inform the processing module to enter a learning mode to be familiar with new commands from a new remote control. The interface module displays guides for the user to learn the operation of the interactive interface.

### FIELD OF THE INVENTION

The invention relates to a remote control learning/identification module and, more particularly, to a remote control learning/identification module received in a TV set and capable of allowing the TV set to adapt itself to receive controlling signals from remote controls of different types.

### BACKGROUND OF THE INVENTION

Currently, the most popular home entertainment around the world is perhaps the television programs Every day, family members getting in front of the TV set and watch their favorite TV programs seems to be a habit or a ritual that almost all families do the same thing around the same time. It's inevitable to say that no wonder the TV industry is so booming these days. Recent years, along with the technology advances and market demands, more and more TV set manufacturers are putting their efforts in making more sophisticated and modern TV set to satisfy customers' needs. However, as there are more and more TV sets available in the market, there are more and more remote controls as well to control the corresponding TV sets. In order to avoid the interferences from the controlling signals sent by different remote controls, each TV set manufacturer uses its own remote control protocol to match with its own brand. Based on the fact mentioned above, different brand of TV set requires a unique remote control, which often causes great confusion in the market. That is, whenever the remote control is lost or damaged, it causes a great deal of effort for the TV set owner finding a suitable remote control to once again control the function of the TV set.

To solve the problem, a substitute remote control is thus introduced to the market, where the substitute remote control is able to learn the infrared code specially designed for the original remote control. After the infrared code is saved, a transmission module inside the substitute remote control restores the code and then the substitute remote control is able to control the TV set. The introduction of the substitute remote control solves the problem that the original remote control is lost and there is no way for the TV set owner to continue to control the TV set remotely.

Even so, the introduction of the substitute remote control requires the user to put another investment to purchase a different remote control. Also, the substitute remote control often has limited function buttons and is not able to fully control all the functions equipped with the original remote control.

### SUMMARY OF THE INVENTION

The primary objective of the present invention is to provide a remote control learning/identification module in combination with a TV set allowing the TV set to automatically learn controlling commands from different brands of remote controls.

Another objective of the present invention is to provide a remote control learning/identification module consisting of command receiving module, store module, activation module and interface module, and processing module. The processing module is connected to the command receiving module, the store module, the activation module and the interface module. The command receiving module receives infrared signal from the remote control and the infrared signal is magnified and modulated to become a level signal. The store module stores system program, standard protocol, the mapping unit information and the user's information. The activation module sends in predetermined command to inform the processing module to enter a learning mode to be familiar with new commands from a new remote control. The interface module displays guides for the user to learn the operation of the interactive interface. The interactive interface is built in the OSD (on screen display) of the TV set and has an analog remote icon with virtual control buttons for the control of the TV set.

The processing module includes a signal sampling unit, identification matching unit, judging unit, decoding unit and mapping unit. The signal sampling unit takes samples from the received signal by the command receiving module to have typical characteristic signal. The identification matching unit compares the characteristic signal(s) received by the signal sampling unit with the standard signal in the protocol bank to have standard protocol. The judging unit determines whether the decoding is accurate and ensures that the protocol standard is accurate based on the standard protocol acquired from the identification matching unit. The decoding unit proceeds with the decoding according to the confirmed protocol standard. The mapping unit completes the mapping of codes. That is, the mapping unit adds in new code number under the same operational commands of the original remote control to build a mapping relationship between the new commands and the commands inside the system.

The activation module is connected to control keys mounted on the TV set or the original remote control.

The control method of the present invention includes the steps of:

1. providing power to allow the remote control learning/identification module to enter standby mode;

2. initializing the TV set or the original remote control which is connected to the activation module and a guide being presented by the interface module to determine whether a learning mode should be processed;

3. sending out predetermined commands by the activation module to the processing module after entering the learning mode and an identification for standard protocol being shown on a TV screen;

4. confirming the identification result by a remote control learning/identification module to allow the selected protocol to replace an old protocol;

5. presenting a guide on the TV screen by the interface module to allow a user to proceed learning operation, wherein a set of virtual control keys are presented for the user to select;

6. pressing a key on a new remote control corresponding to the specific virtual control key to send out a control signal to be received, modulated, decoded and automatically stored by the learning/identification module;

7. sequentially presenting guides by the interface module for the user to press the virtual control key;

8. repeating steps 6 and 7 until the learning is finished;

9. establishing a mapping list by the mapping unit to represent key codes of a substitute remote control, wherein the mapping list is stored in the store module;

10. presenting a second mapping list saved by the learning identification module for selection;

11. initializing the TV set to allow the TV set to use the selected mapping list.

The identification and confirming steps in steps 3 and 4 as above, the identification includes active identification and passive identification.

Active Identification:

After the active identification is selected under the learning mode, a random key from the substitute remote control is pressed to send out a control signal. After the control signal is picked up by the command receiving module, the signal sampling unit in the processing module takes sample from the signal received and concludes a characteristic signal. The identification matching unit compares the characteristic signal from the signal sampling unit with the standard protocol bank to conclude a new standard protocol. The judging unit decodes the new standard protocol and determines the accuracy of the decoding. After the above processes are completed, the method enters step 5.

Passive Identification

After the passive identification is selected, a standard protocol list saved in the store module is presented for selection and confirmation. After the protocol is selected, the method enters step 5.

The remote control is not just suitable for TV remote control, it may also be suitable for DVD player or other remote control sending out infrared control commands.

The advantages of the present invention include the followings. Adding the learning and identification module of the present invention allows the learning and identification module to learn different remote control protocol and commands to control the TV set. Therefore, when the original remote control is lost or missing, the user may use the existing remote control applied for other electrical appliances to continue controlling the TV set without any cost or effort trying to gain the control of the TV set.

### BRIEF DESCRIPTION OF THE DRAWINGS

FIG. 1 is a schematic view showing the structure of the TV set of the present invention;

FIG. 2 is a control flow chart of the remote control learning/identification module in combination with the TV set of the present invention; and

FIG. 3 is a schematic view showing the analog remote control of the present invention.

### DETAILED DESCRIPTION OF THE INVENTION

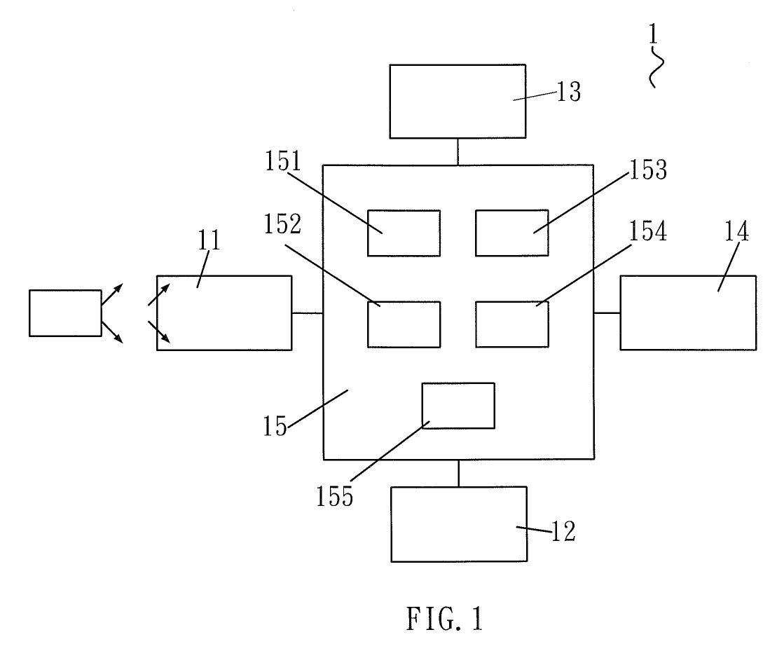

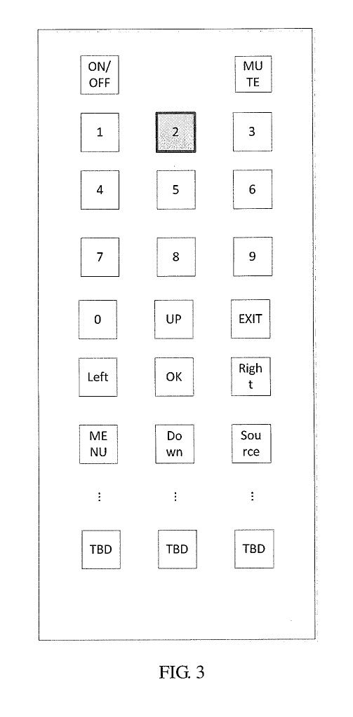

As shown in FIGS. 1, 2 and 3, a remote control learning/identification module 1 in combination with a TV set allows the TV set to automatically learn controlling commands from different brands of remote controls.

The remote control learning/identification module 1 of the present invention consists of command receiving module 11, store module 12, activation module 13, interface module 14, and processing module 15. The processing module 15 is connected to the command receiving module 11, the store module 12, the activation module 13 and the interface module 14. The command receiving module 11 receives infrared signal from the remote control and the infrared signal is magnified and modulated to become a level signal. The store module 12 stores system program, standard protocol, the mapping unit information and the user's information. The activation module 13 sends in predetermined command to inform the processing module 15 to enter a learning mode to be familiar with new commands from a new remote control. The interface module 14 displays guides for the user to learn the operation of the interactive interface. The interactive interface is built in the OSD (on screen display) of the TV set and has an analog remote icon with virtual control buttons for the control of the TV set.

The processing module 15 includes a signal sampling unit 151, identification matching unit 152, judging unit 153, decoding unit 154 and mapping unit 155. The signal sampling unit 151 takes samples from the received signal by the command receiving module 11 to have typical characteristic signal. The identification matching unit 152 compares the characteristic signal(s) received by the signal sampling unit 151 with the standard signal in the protocol bank to have standard protocol. The judging unit 153 determines whether the decoding is accurate and ensures that the protocol standard is accurate based on the standard protocol acquired from the identification matching unit 152. The decoding unit 154 proceeds with the decoding according to the confirmed protocol standard. The mapping unit 155 completes the mapping of codes. That is, the mapping unit 155 adds-in new code number under the same operational commands of the original remote control to build a mapping relationship between the new commands and the commands inside the system.

The activation module 13 is connected to control keys mounted on the TV set or the original remote control.

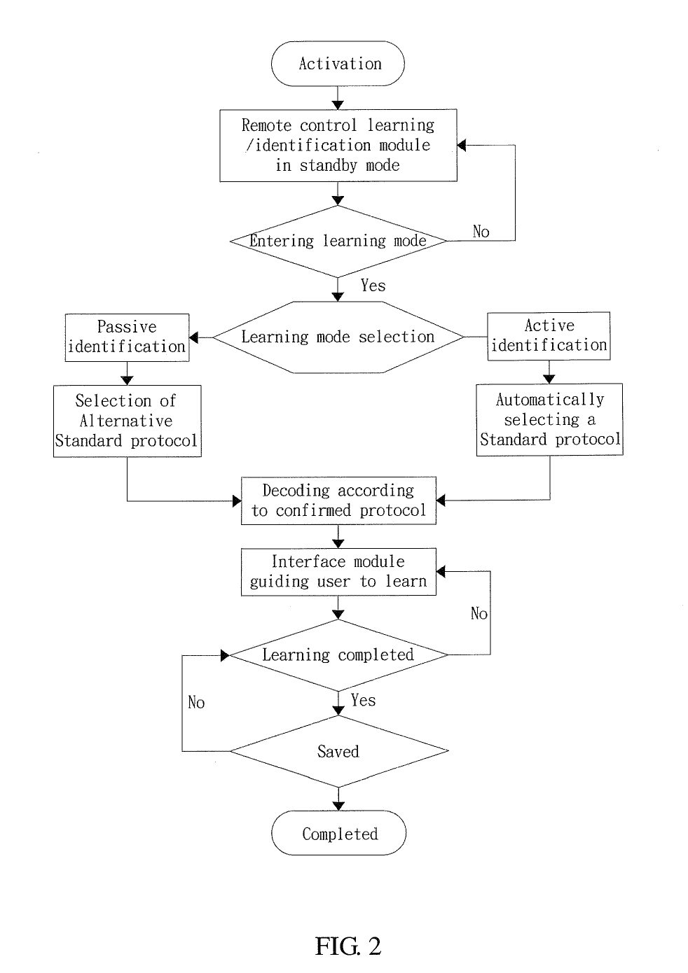

The control method of the present invention includes the steps of, as shown in FIG. 2:

1. providing power to allow the remote control learning/identification module 1 to enter standby mode;

2. initializing the TV set or the original remote control which is connected to the activation module 13 and a guide being presented by the interface module 14 to determine whether a learning mode should be processed;

3. sending out predetermined commands by the activation module 13 to the processing module 15 after entering the learning mode and an identification for standard protocol being shown on a TV screen;

4. confirming the identification result by a remote control learning/identification module 1 to allow the selected protocol to replace an old protocol;

5. presenting a guide on the TV screen by the interface module 14 to allow a user to proceed learning operation, wherein a set of virtual control keys are presented for the user to select;

6. pressing a key on a new remote control corresponding to the specific virtual control key to send out a control signal to be received, modulated, decoded and automatically stored by the learning/identification module 1;

7. sequentially presenting guides by the interface module for the user to press the virtual control key;

8. repeating steps 6 and 7 until the learning is finished;

9. establishing a mapping list by the mapping unit to represent key codes of a substitute remote control, wherein the mapping list is stored in the store module;

10. presenting a second mapping list saved by the learning identification module 1 for selection;

11. initializing the TV set to allow the TV set to use the selected mapping list.

The identification and confirming steps in steps 3 and 4 as above, the identification includes active identification and passive identification.

Active Identification:

After the active identification is selected under the learning mode, a random key from the substitute remote control is pressed to send out a control signal. After the control signal is picked up by the command receiving module 11, the signal sampling unit 151 in the processing module 15 takes sample from the signal received and concludes a characteristic signal. The identification matching unit 152 compares the characteristic signal from the signal sampling unit with the standard protocol bank to conclude a new standard protocol. The judging unit 153 decodes the new standard protocol and determines the accuracy of the decoding. After the above processes are completed, the method enters step 5.

Passive Identification

After the passive identification is selected, a standard protocol list saved in the store module 12 is presented for selection and confirmation. After the protocol is selected, the method enters step 5.

The remote control is not just suitable for TV remote control, it may also be suitable for DVD player or other remote control sending out infrared control commands.

It is to be noted that although the preferred embodiment of the present invention has been described, other modifications, alterations or minor change to the structure should still be within the scope defined in the claims. As those skilled in the art will readily observe that numerous modifications and alterations of the device and method may be made while retaining the teachings of the invention.

What is claimed is:

1. A remote control learning/identification module in combination with a TV set, the remote control learning/identification module comprising:
a command receiving module, a store module, an activation module, an interface module, and a processing module, wherein the processing module is connected to the command receiving module, the store module, the activation module and the interface module, the command receiving module receives infrared signal and the infrared signal is magnified and modulated to become a level signal, the store module stores system program, standard protocol, the mapping unit information and the user's information, the activation module sends in predetermined command to inform the processing module to enter a learning mode to be familiar with new commands, the interface module displays guides for the user, the interactive interface is built in the OSD (on screen display) of the TV set and has an analog remote icon with virtual control buttons for the control of the TV set.

2. The remote control learning/identification module in combination with a TV set as claimed in claim 1, wherein the processing module includes a signal sampling unit, an identification matching unit, a judging unit, a decoding unit and a mapping unit, the signal sampling unit takes samples from received signal by the command receiving module to have typical characteristic signal, the identification matching unit compares the characteristic signal(s) received by the signal sampling unit with standard signal in protocol bank to have a standard protocol, the judging unit determines whether decoding is accurate and ensures that the standard protocol is accurate based on the standard protocol acquired from the identification matching unit, the decoding unit proceeds with the decoding according to the confirmed standard protocol, the mapping unit adds in new code number under same operational commands to build a mapping relationship between the new commands and the commands inside TV set.

3. The remote control learning/identification module in combination with a TV set as claimed in claim 1, wherein the activation module is connected to the control keys which are built in the TV set or an original remote control.

4. A remote control learning/identification method used in the remote control learning/identification module in combination with a TV set, comprising the steps of:
1. providing power to allow the remote control learning/identification module to enter a standby mode;
2. initializing the TV set or an original remote control which is connected to the activation module and a guide being presented by the interface module to determine whether a learning mode should be processed;
3. sending out predetermined commands by the activation module to the processing module after entering the learning mode and an identification for standard protocol being shown on a TV screen;
4. confirming the identification result by a remote control learning/identification module to allow selected protocol to replace an old protocol;
5. presenting a guide on the TV screen by the interface module to allow a user to proceed learning operation, wherein a set of virtual control keys are presented for the user to select;
6. pressing a key on a new remote control corresponding to the specific virtual control key to send out a control signal to be received, modulated, decoded and automatically stored by the learning/identification module;
7. sequentially presenting guides by the interface module for the user to press the virtual control key;
8. repeating steps 6 and 7 until the learning is finished;
9. establishing a mapping list by the mapping unit to represent key codes of a substitute remote control, wherein the mapping list is stored in the store module;
10. presenting a second mapping list saved by the learning identification module for selection;
11. initializing the TV set to allow the TV set to use the selected mapping list.

5. The method as claimed in claim 4, wherein the identification includes active identification and passive identification, in active identification,
after the active identification is selected under the learning mode, a random key from the substitute remote control is pressed to send out a control signal and after the control signal is picked up by the command receiving module, the signal sampling unit in the processing module takes sample from the signal received and concludes a characteristic signal, the identification matching unit compares the characteristic signal from the signal sampling unit with the standard protocol bank to conclude a new standard protocol, the judging unit decodes the new standard protocol and determines the accuracy of the decoding, after the above processes are completed, the method enters step 5.
in passive identification
after the passive identification is selected, a standard protocol list saved in the store module is presented for selection and confirmation, after the protocol is selected, the method enters step 5.
